(19) United States
(12) Patent Application Publication
(10) Pub. No.: US 2023/0388458 A1
(43) Pub. Date: Nov. 30, 2023

(54) SEED TUBE CAMERA AND RELATED DEVICES, SYSTEMS, AND METHODS

(71) Applicant: Ag Leader Technology, Ames, IA (US)

(72) Inventors: Scott Eichhorn, Ames, IA (US); Brett Buehler, Dallas Center, IA (US); Alan F. Barry, Nevada, IA (US)

(21) Appl. No.: 18/203,206

(22) Filed: May 30, 2023

Related U.S. Application Data
(60) Provisional application No. 63/346,665, filed on May 27, 2022.

(51) Int. Cl. H04N 7/18; A01C 7/10; A01B 79/02

(52) U.S. Cl. CPC H04N 7/183; A01C 7/105; A01B 79/02; A01C 5/064

(57) ABSTRACT

A planting system comprising a camera disposed at a distal end of a seed tube at or below ground level. The system may also include a processor in communication with the camera configured to processes images from the camera, and be configured to conduct image analysis to detect planting conditions including one or more of collapsed trench sidewalls, seed placement, crop residue within the trench, clods within the trench, a collapsed trench, “W” trench, trench size, seed depth, closing wheel operations, soil moisture, and seed bounce. The system may also include a command module in communication with the processor configured to automatically adjust one or more of planter row cleaners, supplemental row unit down force, supplemental closing wheel down force, closing wheel configuration, deployment of seed firmers, timing of application of liquid treatment, and seed meter ejection in response to detected planting conditions.

### CROSS-REFERENCE TO RELATED APPLICATION(S)

This application claims the benefit under 35 U.S.C. § 119(e) to U.S. Provisional Application 63/346,665, filed May 27, 2022, and entitled “Seed Delivery Tube Camera for Furrow Monitoring”, which is hereby incorporated herein by reference in its entirety for all purposes.

### TECHNICAL FIELD

The disclosure relates to agricultural planters and real-time monitoring during planting processes.

### BACKGROUND

As would be appreciated most modern corn planter row units operate by opening a furrow in the soil, depositing a seed from a delivery tube into the furrow, then closing the furrow with a collection of closing and/or press wheels. This process is not visible to the equipment operator seated in the tractor cabin. There are problems that can occur during this process that can reduce the germination and/or health of the plant and ultimately reduce the amount of grain yield during harvest. These problems can include crop reside in the seed furrow, soil clods in the seed furrow, dry topsoil falling into the furrow, collapsing or blown out furrow sidewalls, improper seed planting depth, improper furrow closure, air voids in the closed furrow, inconsistent seed to soil contact, and other problems that would be appreciated by those of skill in the art.

Currently the operator must stop the equipment and carefully dig into the seed furrow to observe the quality of the furrow formation, seed placement, and closure. This process is time-consuming and requires a degree of skill and/or training as well as being subjective in many aspects. Even by manually observing the furrow and/or seed it can be difficult to determine the root cause of any problems discovered because only the end results of the process can be observed.

Prior known solutions propose mounting visual sensors or cameras 8 between the opening disks 12 and the closing wheels 18 of a row unit 10 to capture images of the seed furrow 2 while it is still open. An implementation of a prior system can be seen in FIG. 1, where a camera 8 is positioned on the row unit 10 between the opening disk 12 and closing disk 18 providing a top-down view. These views can provide basic feedback on furrow 2 formation, seed 20 placement, and if there is debris falling into the furrow 2. Exemplary views from theses prior known systems are shown in FIGS. 2 and 3. However, the top-down perspective provided makes it difficult to assess the depth of the furrow 2 and/or seed 20 planting depth. Additionally, dust that is commonly generated during planting can also obscure the view of the furrow 2, as shown in FIG. 3.

### BRIEF SUMMARY

In Example 1 a system for monitoring a seed trench comprising a vision sensor disposed at a distal end of a seed tube.

Example 2 relates to the system of Example 1, further comprising a video processor in communication with the vision sensor, and a display in communication with the video processor, wherein the display is configured to display images from the vision sensor to an operator.

Example 3 relates to the system of Examples 1-2, wherein the vision sensor faces a closing disk, and wherein the vision sensor is disposed at or below ground level during planting operations.

Example 4 relates to the system of Examples 1-3, wherein the system is configured to detect one or more of collapsed trench sidewalls, seed placement, crop residue within the trench, clods within the trench, a collapsed trench, “W” trench, trench size, seed depth, closing wheel operations, and soil moisture.

Example 5 relates to the system of Examples 1-4, wherein the system is configured to detect seed bounce by comparing a seed path through images from the vision sensor to a desired seed path.

Example 6 relates to the system of Examples 1-5, wherein the display is configured display notifications to an operator of detected conditions.

Example 7 relates to the system of Examples 1-6, further comprising at least one control module in communication with the display and wherein the system is configured to send commands to the at least one control module to adjust one or more of seed meter ejection, in-furrow liquid treatment, supplemental row unit down force, supplemental closing wheel down force, seed firmer deployment and down force, row cleaners, and gauge wheel load.

Example 8 relates to the system of Examples 1-7, further comprising a supplemental lighting source disposed near the vision sensor.

Example 9 relates to the system of Examples 1-8, further comprising a storage medium in communication with the video processor and configured to store images from the vision sensor.

Example 10 relates to the system of Examples 1-9, further comprising one or more additional sensors including a stereo camera and time-of-flight sensor.

Example 11 relates to the system of Examples 1-10, wherein the vision sensor is an RG BB camera.

In Example 12, an agricultural monitoring and control system comprising a vision sensor mounting at a distal end of a seed tube and configured to capture images of an open seed trench, a video processor in communication with the vision sensor, a control module in communication with the video processor, a storage medium in communication with the video processor, configured to store images from the vision sensor, and a display in communication with the vision sensor, configured to display to an operator images from the vision sensor, wherein the system is configured to detect one or more planting condition including collapsed trench sidewalls, seed placement, crop residue within the trench, clods within the trench, a collapsed trench, “W” trench, trench size, seed depth, closing wheel operations, soil moisture, and seed bounce, and wherein the control module is configured to send command to equipment on a row unit to correct detected planting conditions.

Example 13 relates to the system of Example 12, further comprising a supplemental lighting source disposed near the vision sensor.

Example 14 relates to the system of Examples 12-13, further comprising displaying alerts of detected planting conditions to an operator via the display.

Example 15 relates to the system of Examples 12-14, wherein planting conditions are detected via machine learning vision.

Example 16 relates to the system of Examples 12-15, further comprising a GNSS unit in communication with the video processor, and wherein the system is configured to record geolocations for the images from the vision sensor.

Example 17 relates to the system of Examples 12-16, wherein planting conditions are corrected by adjusting one or more of planter row cleaners, supplemental row unit down force, supplemental closing wheel down force, closing wheel configuration, deployment of seed firmers, timing of application of liquid treatment, and seed meter ejection.

Example 18 relates to the system of Examples 12-17, further comprising one or more additional sensors including a stereo camera and time-of-flight sensor.

Example 19 relates to the system of Examples 12-18, wherein the vision sensor is an RGB camera.

In Example 20, a planting system comprising: a camera disposed at a distal end of a seed tube at or below ground level; a supplemental light disposed on the seed tube, configured to illuminate a field-of-view of the camera; a processor in communication with the camera configured to processes images from the camera, wherein the processor is configured to conduct image analysis to detect planting conditions including one or more of collapsed trench sidewalls, seed placement, crop residue within the trench, clods within the trench, a collapsed trench, “W” trench, trench size, seed depth, closing wheel operations, soil moisture, and seed bounce; a display in communication with the camera and processor configured to display images from the camera to an operator and to display notification of detected planting conditions; a command module in communication with the processor configured to automatically adjust one or more of planter row cleaners, supplemental row unit down force, supplemental closing wheel down force, closing wheel configuration, deployment of seed firmers, timing of application of liquid treatment, and seed meter ejection in response to detected planting conditions; and a storage medium in communication with the processor configured to store images from the camera.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a side view of planter row unit of the prior art.

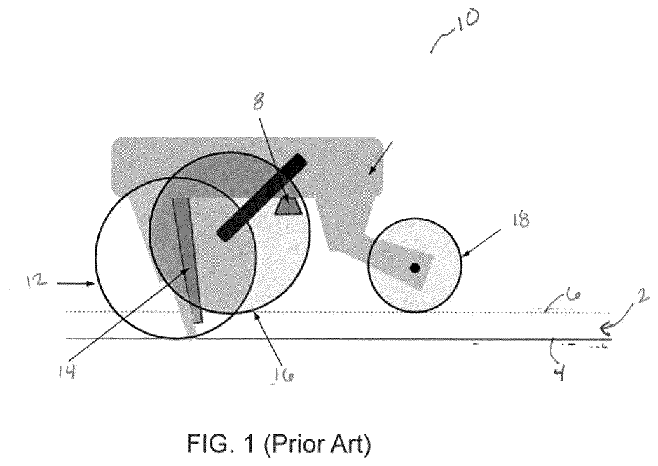

FIG. 2 is an exemplary image from a prior art imaging system.

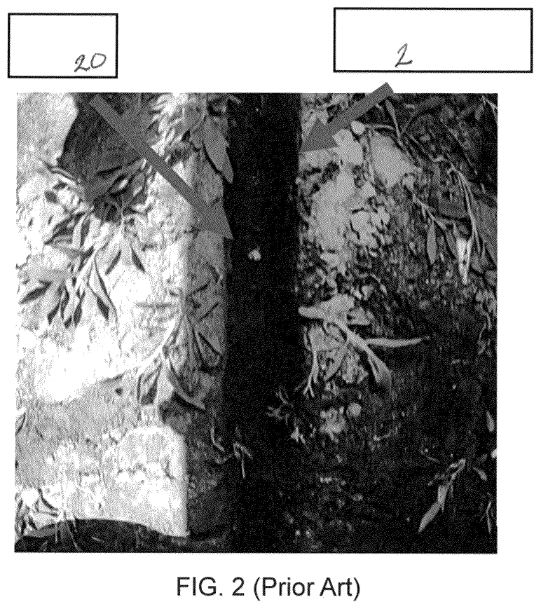

FIG. 3 is an exemplary image from a prior art imaging system.

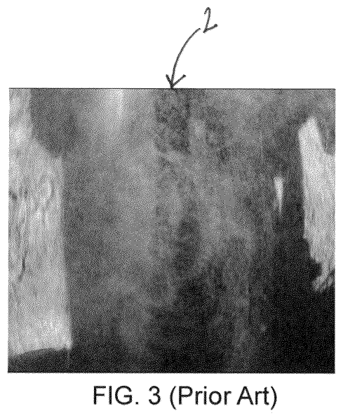

FIG. 4 is a side view of a row unit having a vision sensor on the seed tube, according to one implementation.

FIG. 5 is a top view of a row unit having a vision sensor on the seed tube, according to one implementation.

FIG. 6 is a rear view of a vision sensor on the seed tube, according to one implementation.

FIG. 7 is an exemplary image from a vision sensor showing sidewall collapse, according to one implementation.

FIG. 8 is an exemplary image from a vision sensor showing a planted seed, according to one implementation.

FIG. 9 is an exemplary image from a vision sensor showing crop residue in the trench, according to one implementation.

FIG. 10 is an exemplary image from a vision sensor showing a trench with many clods, according to one implementation.

FIG. 11 is an exemplary image from a vision sensor showing trench collapse, according to one implementation.

FIG. 12 is an exemplary image from a vision sensor showing a “W” trench, according to one implementation.

FIG. 13 is an exemplary image from a vision sensor showing a narrow trench, according to one implementation.

FIG. 14 is an exemplary image from a vision sensor showing sidewall blowout, according to one implementation.

FIG. 15 is an exemplary image form a vision sensor showing a shallow seed, according to one implementation.

FIG. 16 shows a supplemental lighting device, according to one implementation.

FIG. 17 is a side view of a row unit having supplemental lighting, according to one implementation.

FIG. 18 is a side view of a row unit implementing the system, according to one implementation.

FIG. 19 is a side view of a row unit implementing a system controlling supplemental row unit down force, according to one implementation.

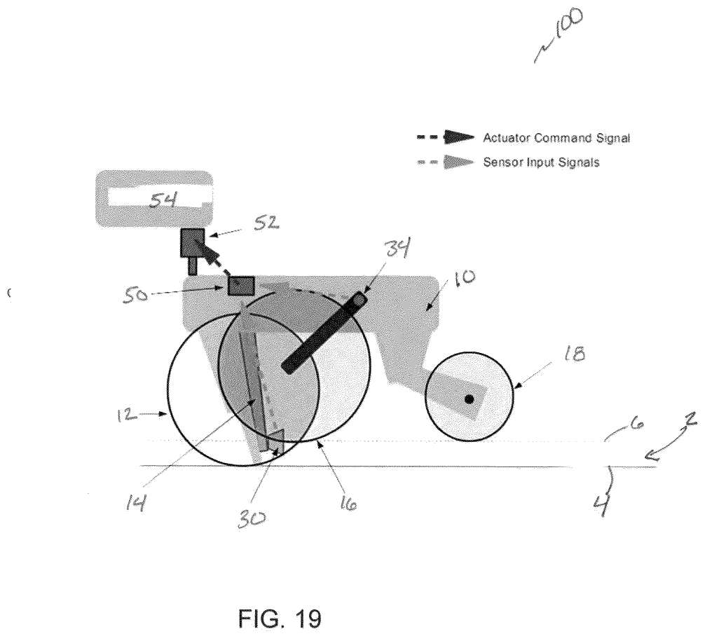

FIG. 20 is a side view of a row unit implementing a system controlling supplemental closing wheel down force, according to one implementation.

FIG. 21 is a side view of a row unit implementing a system controlling a seed firmer, according to one implementation.

FIG. 22 is a side view of a row unit implementing a system controlling a seed meter, according to one implementation.

FIG. 23 is a side view of a row unit having a vision sensor and one or more additional sensors, according to one implementation.

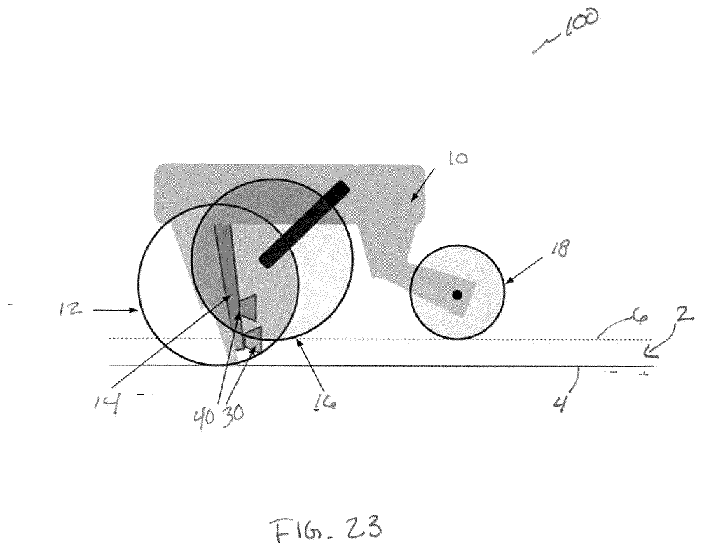

### DETAILED DESCRIPTION

Disclosed herein is an agricultural monitoring system and particularly a system for observing and monitoring agricultural planting including high speed planting. In various implementations, the system includes a camera (also referred to herein as a “vision sensor”) mounted near the bottom of a seed delivery tube facing the rear of a row unit toward the closing wheels. This viewing perspective, looking along the seed furrow (also referred to herein a “seed trench” or “trench”) and parallel to the ground, provides a view of the vertical axis of the seed placement and furrow conditions.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16,523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. patent application Ser. No. 16/918,300, filed Jul. 1, 2020, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. patent application Ser. No. 16/997,040, filed Aug. 19, 2020, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed November 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. patent application Ser. No. 17/225,740, filed Apr. 8, 2021, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,678, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/081,432, filed Dec. 14, 2022, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,801, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. Patent Application 63/351,602, filed Jun. 13, 2022, entitled “Apparatus, Systems and Methods for Image Plant Counting,” U.S. Patent Application 63/357,082, filed Jun. 30, 2022, entitled “Seed Tube Guard,” U.S. Patent Application 63/357,284, filed June 2022, entitled “Grain Cart Bin Level Sharing,” U.S. Patent Application 63/394,843, filed Aug. 3, 2022, entitled “Hydraulic Cylinder Position Control for Lifting and Lowering Towed Implements,” U.S. Patent Application 63/395,061, filed Aug. 4, 2022, entitled “Seed Placement in Furrow,” U.S. Patent Application 63/400,943, filed Aug. 25, 2022, entitled “Combine Yield Monitor,” U.S. Patent Application 63/406,151, filed Sep. 13, 2022, entitled “Hopper Lid with Magnet Retention and Related Systems and Methods,” U.S. Patent Application 63/427,028, filed Nov. 21, 2022, entitled “Stalk Sensors and Associated Devices, Systems and Methods,” U.S. Patent Application 63/445,960, filed Feb. 15, 2023, entitled “Ear Shelling Detection and Related Devices, Systems, and Methods,” U.S. Patent Application 63/445,550, filed Feb. 14, 2023, entitled “Liquid Flow Meter and Flow Balancer,” U.S. Patent Application 63/466,144, filed May 12, 2023, entitled “Devices, Systems, and Methods for Providing Yield Maps,” and U.S. Patent Application 63/466,560, filed May 15, 2023, entitled “Devices, Systems, and Methods for Agricultural Guidance and Navigation,” each of which is incorporated herein by reference for all purposes.

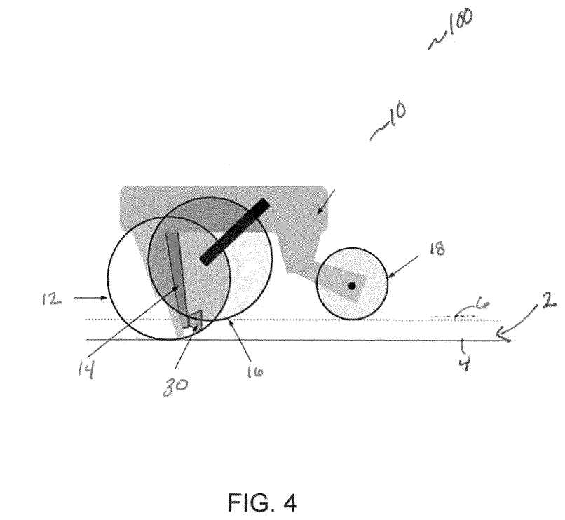

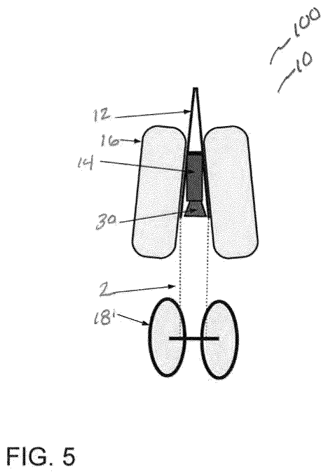

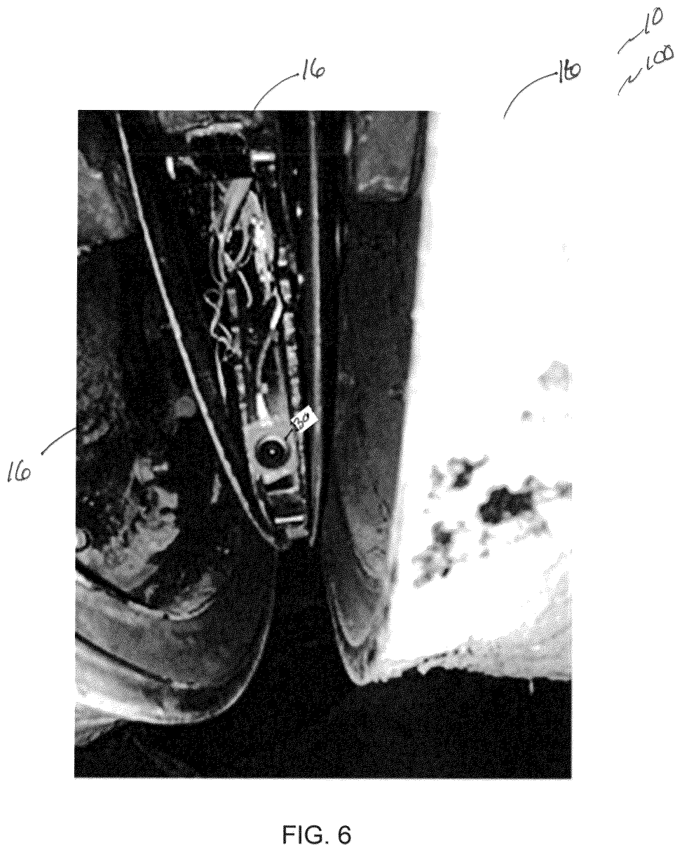

Turning to the figures in further detail, FIGS. 4-6 show an exemplary implementation of the system 100. In various implementations, the system 100 operates on and in conjunction with an agricultural row unit 10. As would be understood by those of skill in the art, row units 10 can be in a number of configurations and are made of multiple components such as opening disks 12, a seed tube 14, gauge wheels 16, closing disks 18, and others as would be appreciated. It would further be understood that a planter typically consists of multiple, substantially identical row units 10. In various implementations, the vision sensor 30 of the system 100 is disposed on each row unit 10 of a particular planter. In alternative implementations, only one or a select number of row units 10 of a planter include a vision sensor 30.

As can be seen in FIG. 4, the system 100 includes a vision sensor 30 (also referred to herein as a “camera” 30) mounted on the seed tube 14 facing the rear of the row unit 10. In various implementations, the vision sensor 30 may be mounted on a different or specialized mounting point that provides a substantially similar view as a vision sensor 30 mounted on the seed tube 14. That is, the vision sensor 30 points toward the closing wheels 18 from a located just behind the opening disks 12, such as to capture an image of the seed trench 2 while it is open including after a seed is placed in the trench 2.

In these and other implementations, the camera 30 is optionally disposed within the open seed trench 2. In further implementations, the camera 30 may not be disposed below ground level 6 but is instead at or near ground level 2 such as to provide a view of the seed trench 2 including the bottom 4 of the trench. In these implementations the vision sensor 30 is much closer to the seed furrow 2 than prior known systems, discussed above, and as a result is less affected by the dust and debris generated during planting.

In various implementations, the camera 30 and any associated cabling/wires can be built into the seed delivery tube 14 and thus be protected from damage. Mounting of the vision sensor 30 on the seed tube 14 can be used in implementations with both powered and unpowered seed tubes, such as the Ag Leader® SureSpeed system or John Deere® translucent seed tube, or any other seed metering system as would be appreciated by those of skill in the art.

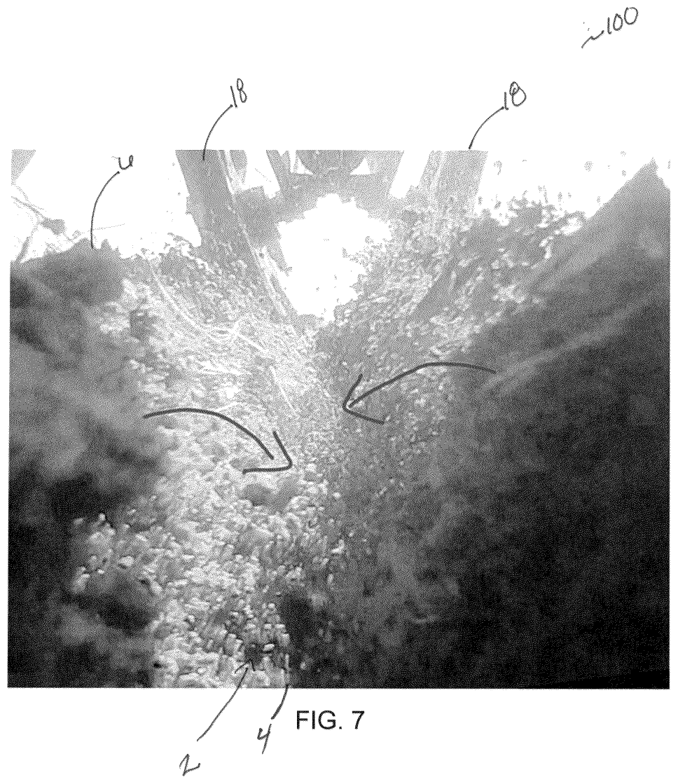

FIGS. 7-15 show various exemplary images from the vision sensor 30 of the system 100 described herein. As can be seen in these images and as will be explained further below the vision sensor 30 and system 100 are capable of detecting a number of agricultural and planting conditions that may not otherwise be easily observable and that may affect planting, harvest, and overall yield.

FIG. 7 shows an exemplary image were the sidewalls of the trench 2 are collapsing. Collapsing side walls can be an indication that there is not enough load being application to the gauge wheels in order to firm the soil and maintain an open trench.

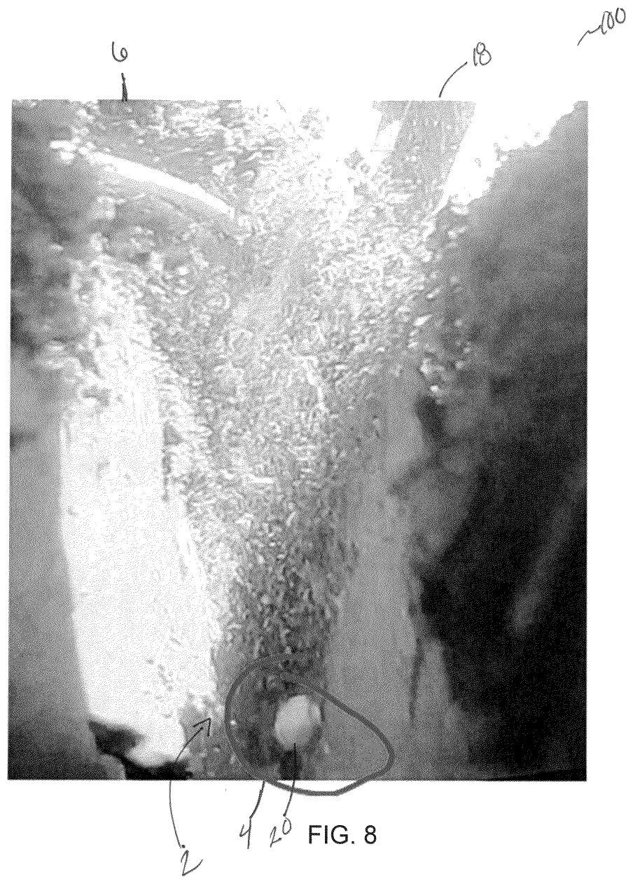

FIG. 8 shows an exemplary image of the trench 2 just after a seed 20 has been placed. In various configurations the seed 20 will come into the field of view of the vision sensor 30 once the seed 20 is at rest in the bottom 4 of the trench 2. As would be appreciated, it is desired for seeds 20 not to bounce upon placement into the trench 2. If the seed 20 does not bounce, then the placement of the seed 20 is not likely to change within the trench, therefore being planting at the selected depth and spacing. In certain implementations, if the seed 20 were to bounce, the bounce may be detected by the vision sensor 30. For example, if the seed 20 experiences zero bounce, the seed 20 will follow a known path along the vison sensor 30 frames defined by the orientation of the vision sensor 30 and the speed of the planter row unit 10 across the ground. The more bounce the seed 20 experiences, the larger the deviation from this defined path that will be observed. Optionally, if a bounce is detected the vision sensor 30 and system 100 may operate to assign a score for the bounce such as via a 1-10 scale or any other appropriate scale as would be understood. For example a score of 1 may be given to a seed 20 that experience zero bounce and a score of 10 may be given to a seed 20 that bounces completely out of the trench 2.

Known seed tubes 14 are generally equipped with sensors to detect the passage of seeds 20 through the tube 14. In various implementations, image capture by the vision sensor 30 may be synchronized, with an optional delay, with a seed tube sensor to capture images when the seed 20 is expected to be visible at a certain location in the image frame. Seed position deviation from the target location could be used to alert/notify an operator to a possible planting issue. The notification/alert may be presented in real-time or near real-time or optionally may be saved and presented at a later time for review.

Further, some in-furrow liquid treatments aim to deposit the dose on and near the seed, such as CapstanAG SelectShot. The vision sensor 30, in various implementations, may be used to detect positional error between the seed 20 location and the dispensed liquid. If a positional error is found, the system 100 may automatically or semi-automatically make an adjustment in the timing of the dispensed liquid to ensure the liquid is applied at the desired time and place, such as directly to the seed 20. Alternately, the timing may be adjusted to apply a treatment in-between seeds, if the product recommends it.

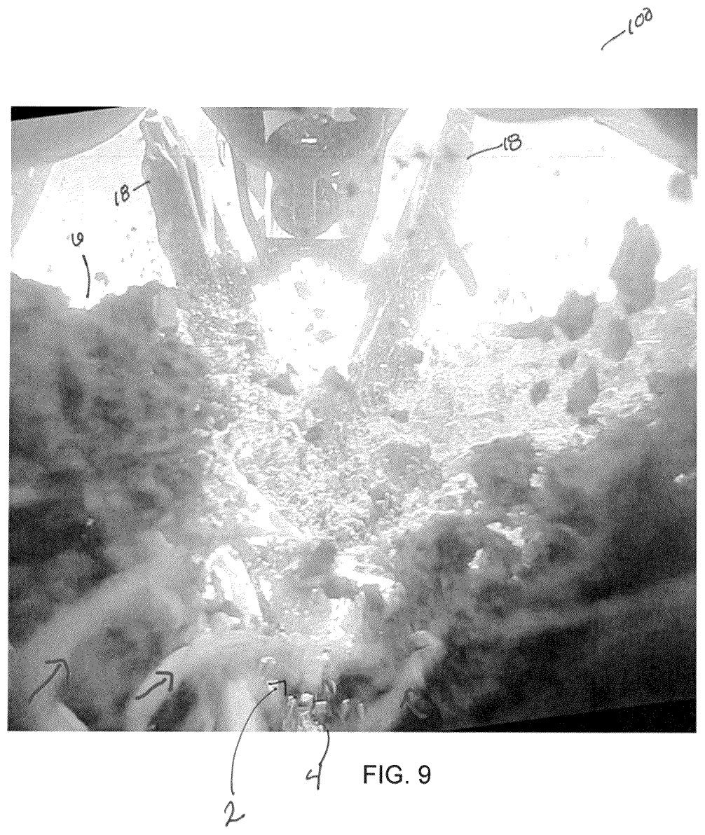

FIG. 9 shows an exemplary view of a trench 2 having crop residue within the trench 2. In this image the crop residue or debris is appearing under the camera 30. As would be appreciated, this can indicate that the row cleaners did not adequately move the crop residue aside and out of the path of the row unit 10. The presence of crop residue can negatively impact seed placement, germination, and overall yield, as would be understood. In various implementations, the system 100 could automatically or semi-automatically adjust the row cleaner of the row unit 10 or planter if crop residue is detected within the trench 2. In addition, the system 100 could be configured to issue an alert or notification to the operator when such conditions exist.

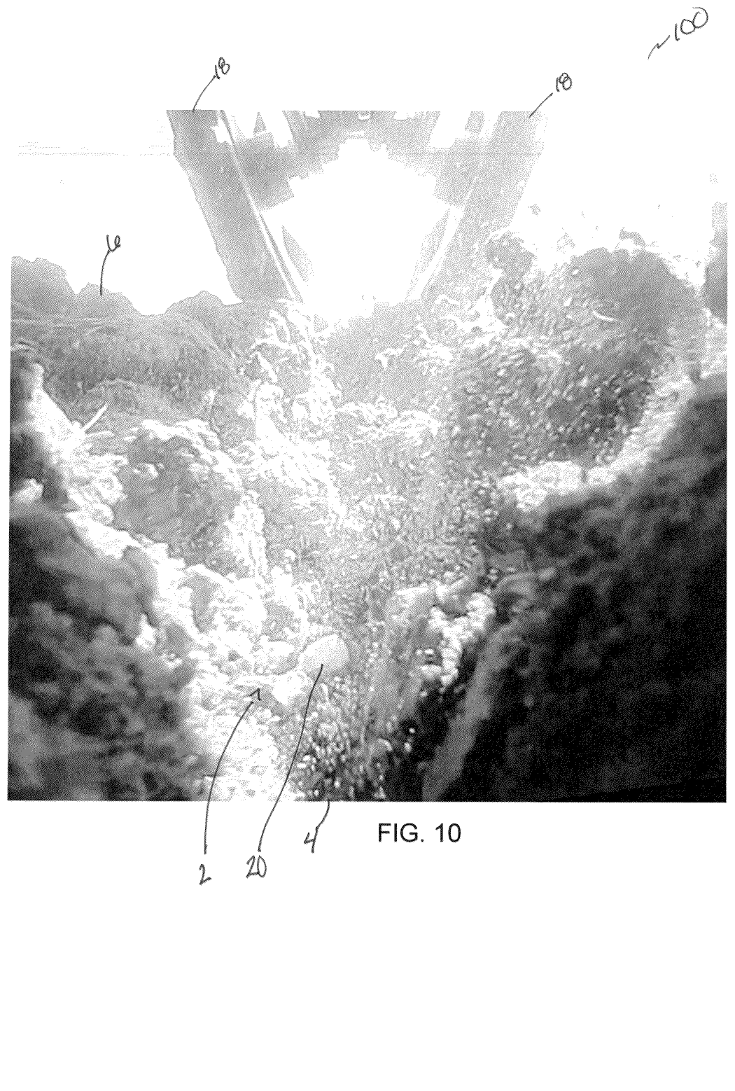

FIG. 10 shows an image of a trench 2 where there is almost no discernable seed trench due to clods. In these and other implementations, the system 100 may automatically or semi-automatically adjust the row cleaners to push more clods aside and/or increase gauge wheel load to in order to break apart or compact the clods in order to form a defined trench 2. Additionally, or alternatively, the system 100 could provide feedback to the operator, such as via an alert or notification, informing the operator of the condition. For example, in conditions where large clods are preventing the trench 2 from being effectively formed wet tillage done earlier in the season may be the problem and an operator can use that information to adjust future practices.

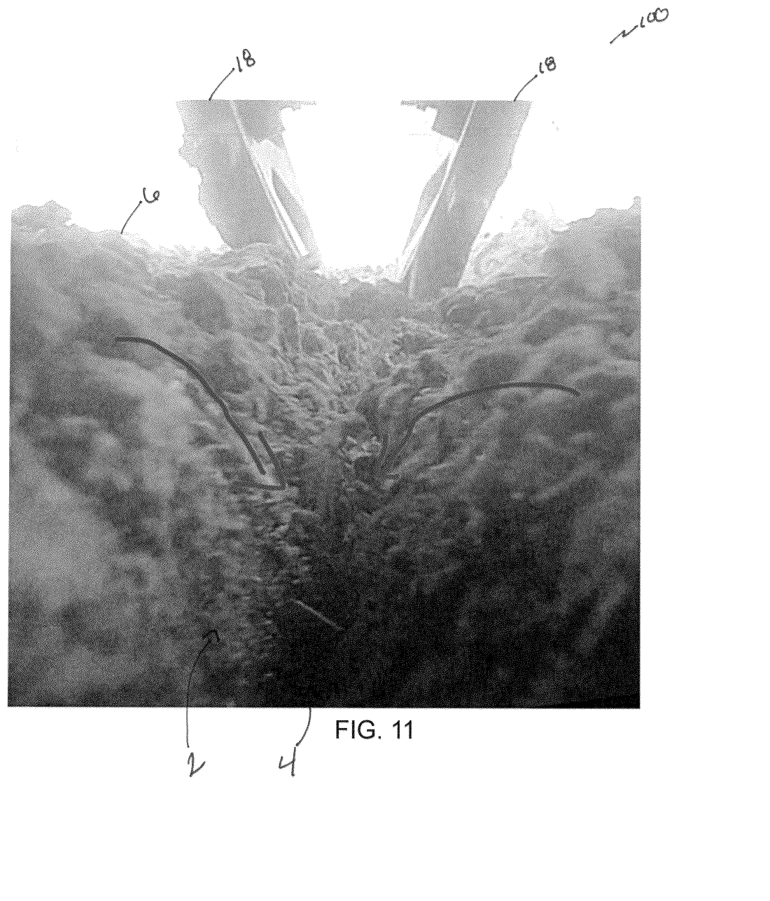

FIG. 11 shows an exemplary trench 2 with trench collapse. As would be understood, one solution to trench collapse is to increase the gauge wheel load and or to use more aggressive row cleaning to push aside the dry soil. These solutions could be automatically or semi-automatically implemented by the system 100 upon detection.

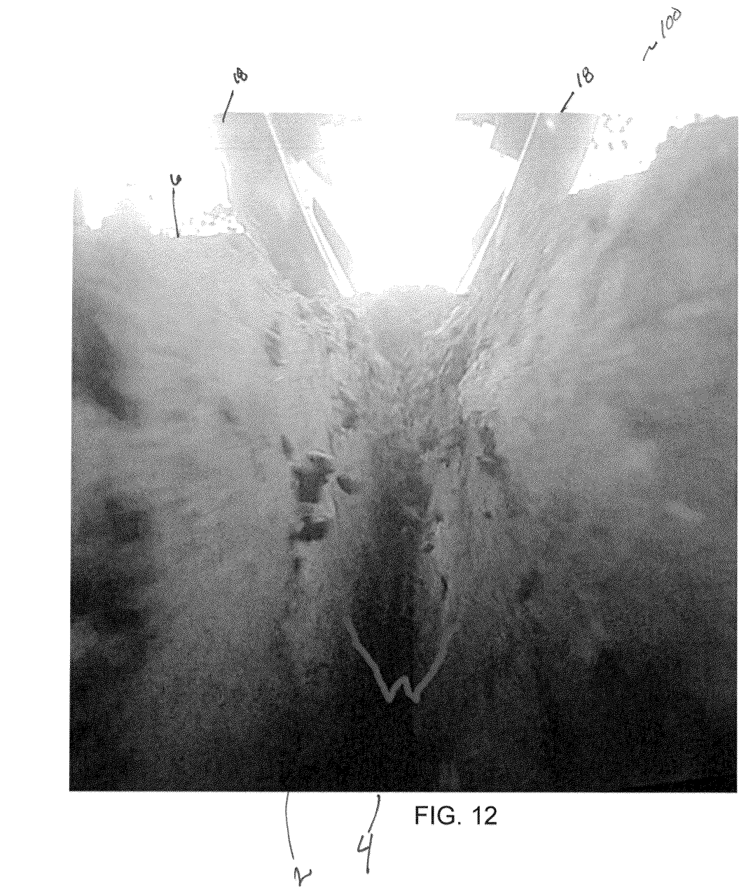

FIG. 12 is an exemplary vision sensor 30 image showing a “W” at the bottom of the trench. As would be appreciated a “W trench” can negatively impart seed 20 placement and therefore overall yield. When this situation is detected the system 100 could alert the operator to the “W trench” such that the operator could know that a part of the row unit 10 may need to be replaced or adjusted.

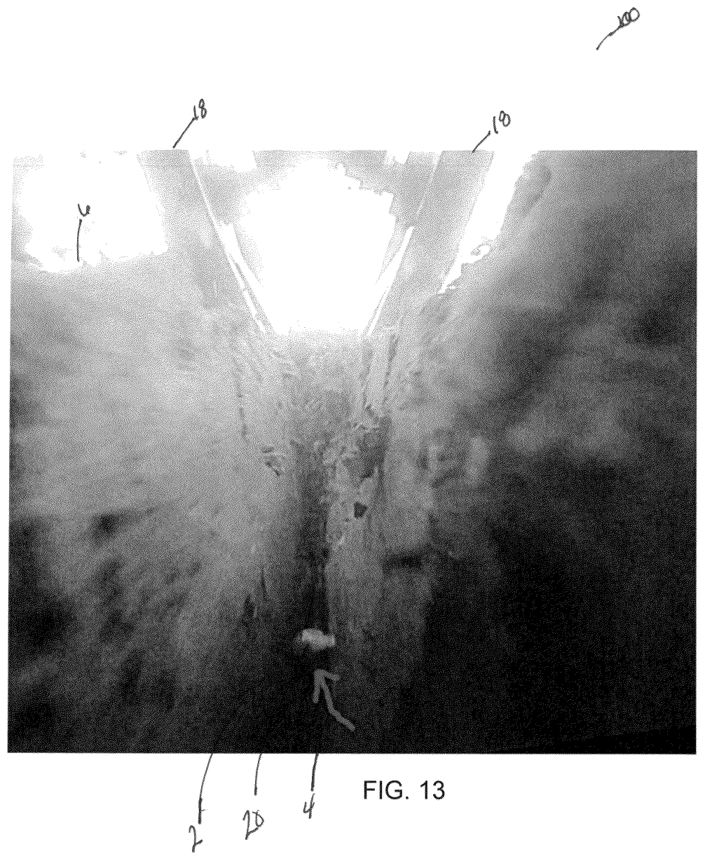

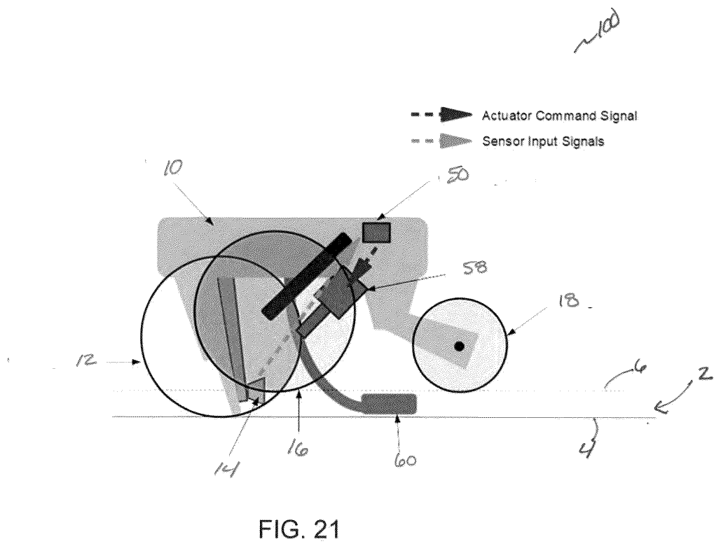

FIG. 13 shows an exemplary image from a vision sensor 30 where the trench 2 is narrow. In conditions where the trench 2 is too narrow the seeds 20 may not reach the bottom 4 of the trench 2. As would be understood if seeds 20 do not make it to the bottom 4 of the trench 2 the seeds 20 will not be planted at the desired depth and/or may not have sufficient seed to soil contact, thereby negatively effecting germination and overall yield at harvest. The system 100 may be configured to monitor for trench 2 size and alert the operator once the trench width becomes unacceptable and seeds 20 cannot make it to the bottom 4 of the trench 2. In certain implementations, a seed firmer (shown in FIG. 21 at 60) may be needed to address the issue thereby pushing the seed 20 to the bottom of the trench 2, as would be understood. The system 100 may automatically or semi-automatically deploy seed firmer if the condition is detected.

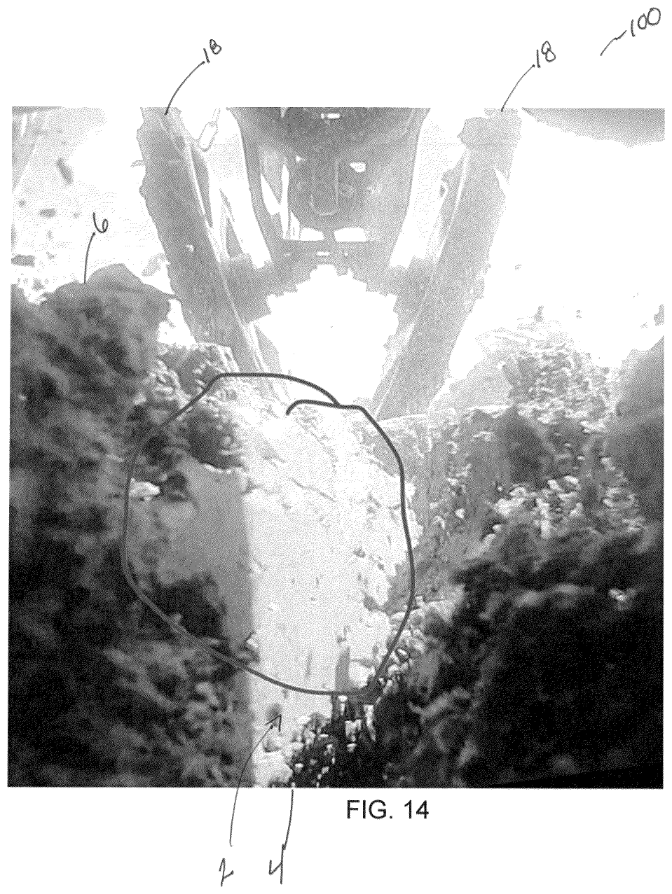

FIG. 14 is an exemplary vision sensor 30 image where there is sidewall blowout within the trench 2. As would be understood, in wet conditions, the sidewall can stick to the opening disk 12 and is ripped out of the trench 2. This is a condition that can cause uneven depth and inconsistent seed to soil contact. As will be discussed further herein, the system 100 can be configured to automatically or semi-automatically detect this condition and take corrective action or prompt corrective action.

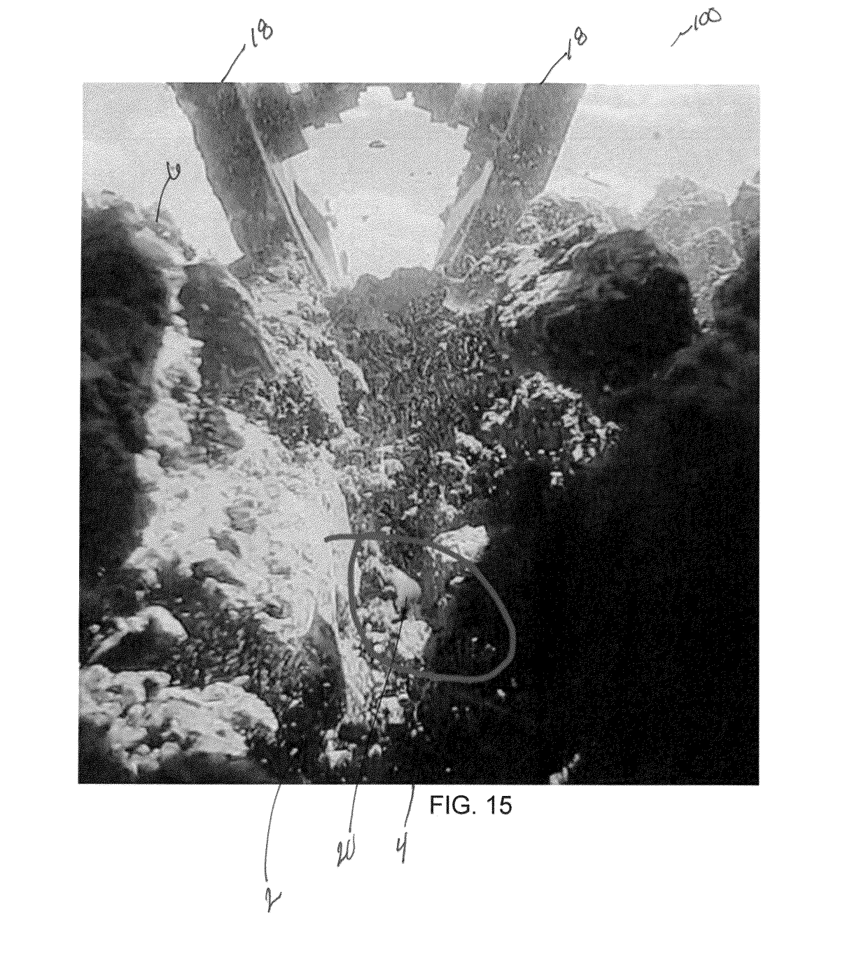

FIG. 15 shows an exemplary image where a shallow seed 20 is present in the trench 2. In various implementations, the vertical position of the seed 20 is paired with a time stamp or other label of when that seed 20 passed a seed depth sensor such that the system 100 can label a depth and location for each seed 20. For example, a floating measurement tool (rule, tape measure, etc.) may be present on a screen displaying the vision sensor 30 images. The measurement tool, in certain implementations, could be configured to lock-on to the position of each seed 20 and travel through the sensor 30 images with the seed 20.

The vision sensor 30 and system 100 could also detect one or more of: if the closing wheels 18 are centered over the trench 2; if the closing wheels 18 are turning; if there is heavy crop residue; are the closing wheel 18 brackets picking up stalks and wedging the stalks into the T handle area; if a stalk is being dragged along the trench 2; if there is poor trench closure, such as on tight contours; if the closing wheel 18 starts to get off the row, such as on tight contours and/or in configurations where the closing wheels 18 are spaced far back from the opening disks 12; if the closing wheels 18 are starting to mud up; if the closing wheels 18 are throwing too much soil or disturbing seed spacing, such as from aggressively spiked closing wheels 18. The vision sensor 30 and system 100 may also be configured to: record “furrowing” that may occur when row cleaners are too aggressive; identify seed 20 spacing after the seed 20 has been deposited into the trench 2; automate closing wheels 18 based off the imagery, such as the force, pitch, spacing, etc. as would be understood.

The vision sensor 30 and system 100 may be further configured to detect dry versus moist soil. As would be understood, soil near the surface 6 often contains less moisture than deeper soil. Seed germination is enhanced when seeds 20 are planted into moist soil. Moist soils often appear darker than dry soils. In various implementations, the moist layer can be identified as a transition from lighter to darker soil in the seed trench 2. In certain implementations, planting depth may be adjusted to ensure planting in soil with desired moisture content.

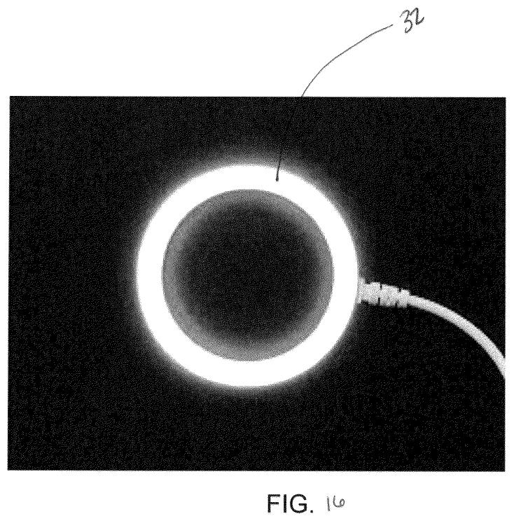

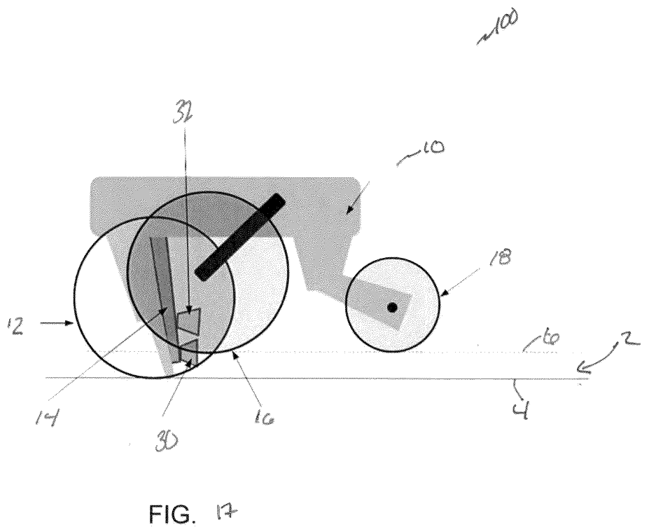

In various implementations, the system 100 may include supplemental lighting 32 that can be mounted nearby the vision sensor 30, shown in FIGS. 16 and 17. In various implementations, the camera(s) 30 and light(s) 32 are built into the seed delivery tube 14 itself. An exemplary ring light 32 is shown in FIG. 16. This ring light 32 or variation thereof can be disposed about the vision sensor 30 to enhance lighting of the field of view of the vision sensor 30. Lighting 32 could alternately be mounted above or below the camera 30 along the seed delivery tube 14, as seen in FIG. 17. Various alternative devices of supplemental lighting 32 are possible and would be appreciated by those of skill in the art.

Lighting 32 intensity may be adjusted as needed to provide the clearest view possible. As would be appreciated, high-intensity lights can generate a large amount of heat. In various implementations, these lighting 32 may be briefly activated only when the vision sensor 30 is recording, thereby reducing the heat generated when compared to continuous operation.

There can exist a wide range of illumination intensity throughout the captured image, from the dark soil shaded by the planter row equipment to the bright sky during midday. This range of illumination, referred to as dynamic range, may exceeds the capability of the vision sensor 30. In various implementations, imaging techniques such as high dynamic range bracketing may be implemented to take multiple image captures of a scene at different exposure levels. These images may then be combined to create a single image containing a larger dynamic range, as would be understood in light of this disclosure.

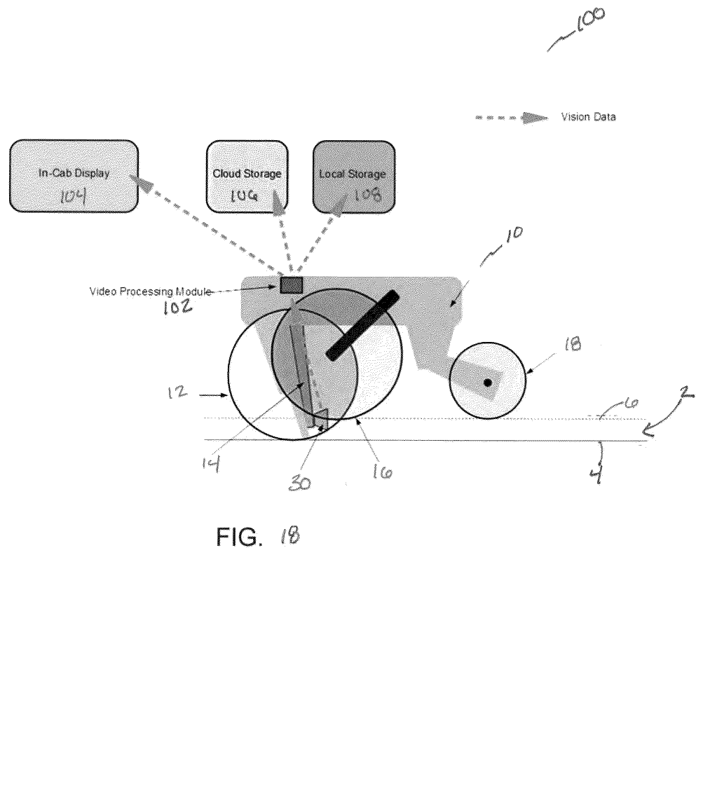

Turning now to FIG. 18, in various implementations, the system 100 includes a video processing module 102, including various software, hardware, and/or firmware components, in operational communication with the vision sensor 30. The visions sensor 20 may be in communication with the video processing module 102 via any appreciated wireless or wired mechanism. In various implementations, the video processing module 102 may be disposed on the row unit 10, tractor, such as in an in-cab display 104, or remotely from the row unit 10 such as in the cloud 106 or other remote device.

In certain implementations, video processing module 102 is in operational communication with an in-cab display 104, such as the InCommand® display from AgLeader®. In these and other implementations, images from the vision sensors 30 can appear in real-time or near real-time to an operator during plating operations. In various further implementations, the video processing module 102 is in communication with the cloud 106 and/or local storage 108 for storing images from the vision sensors 30.

The images and video from the vision sensor 30 may be stored in a short-term buffer of a video processing module 102. From there they can be sent and presented on an in-cab display 104. The video can be presented in real-time, at a reduced playback speed, or as a “frozen frame” to more easily visualize the conditions described previously in relation to FIGS. 7-15. In various implementations, the in-cab operator could select a specific planting row to view or each row could be automatically displayed in turn. Alternatively, if other feedback from a particular row, such as seed singulation, gauge wheel load, applied down force, or ride quality, indicated abnormal behavior the video from that row could be automatically displayed to aid in identifying potential issues.

Optionally, the video could be stored locally in local storage 108 on the planting equipment or transmitted to the cloud 106 in real-time or after operations are complete.

In various implementations, the system 100 may be configured to use machine vision analysis to process the video images and identify potential seed furrow issues such as those described above. Identified problems could be used to alert the machine operator or take automatic, semi-automatic, or manual corrective actions. In various implementations, video clips of detected problems could be stored for later analysis along with a record of the time and location, where a GNSS location is recorded for each seed 20. These video or images could be compiled with other map data such as what is displayed on Ag Leader's AgFiniti® and SMS products, or similar products as would be understood.

In certain implementations, machine learning vision, such as a trained convolutional neural network, could be used to detect the presence or absence of the closing wheels 18 or gauge wheels 16 within a frame. Based on the position of the gauge wheels 16 in the video frame the planting depth could be calculated. Planting depth could also be calculated from the position of the closing wheels 18 in the frame. Additionally, the machine learning vision could detect soil clods and/or collapse of the furrow wall. Machine learning vision may also be implemented to detect any of a number of planting conditions, including collapsed trench sidewalls, seed placement, crop residue within the trench, clods within the trench, a collapsed trench, “W” trench, trench size, seed depth, closing wheel operations, soil moisture, and seed bounce.

In order to achieve a target planting depth and/or trench shape the supplemental row unit 10 down force could be adjusted automatically or semi-automatically. In these or other implementations, the system 100 includes a control module 50 in communication with the vision sensor 30 or video processing module 102. The control module 50 may then be in communication with a down force actuator 52 on the planter toolbar 54 as would be understood. In these and other implementations, the amount of supplemental downforce applied to the row unit 10 can be adjusted based on feedback from the vision sensors 30. The adjustment can be automatic, semi-automatic, or manual as would be understood.

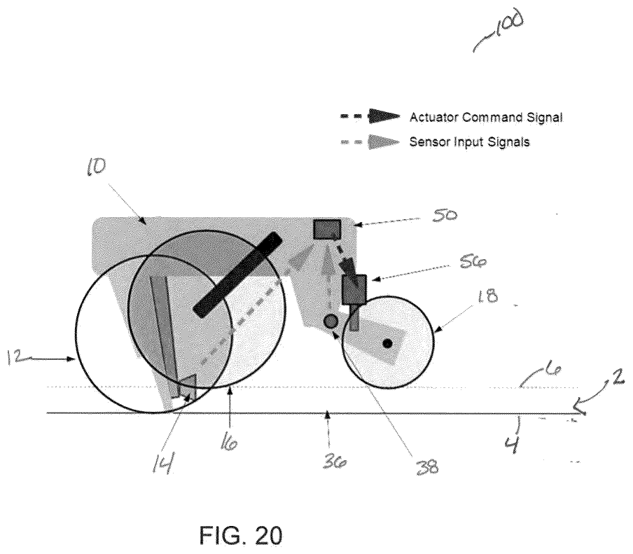

As can be seen in FIG. 20, the amount of supplemental closing wheel force can also be adjusted based on feedback from the vision sensors 30, such as upon detection of voids within the furrow 2. In these and other implementations the vision sensor 30 is in communication with the control module 50 which is then in communication with a closing wheel actuator 56. The adjustment can be automatic, semi-automatic, or manual as would be understood.

In various implementations, the row unit 10 may include a seed firmer 60, as seen in FIG. 21. As would be understood, and as discussed above, a seed firmer 60 can be deployed if the seed is shown as not reaching the bottom 4 of the seed trench 2, such as if the trench 2 in too narrow. In some implementations, the seed firmer 60 is retracted if the system 100 detects excessive soil sticking to a deployed seed firmer 60. Alternately, a system 100 applying supplemental force to the seed firmer 60 could be adjected based on if the seed 20 is reaching the bottom 4 of the seed furrow 2. In these implementations, a firmer actuator 58 in communication with a control module 50 can move the seed firmer 60 between retracted and deployed positions and, optionally, apply supplemental down force to the firmer 60.

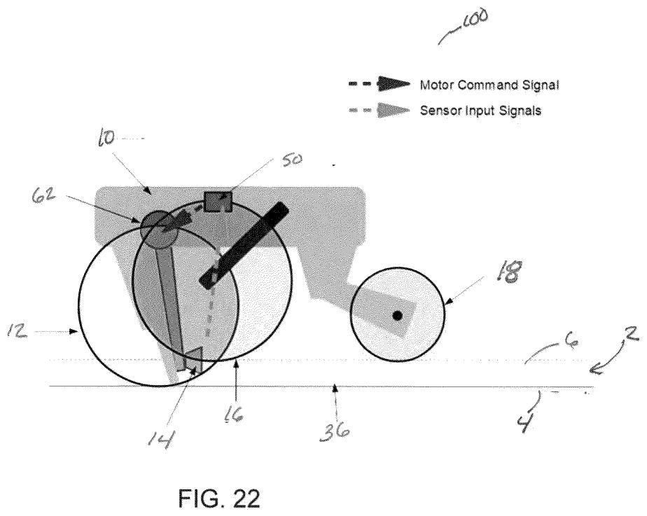

Turning to FIG. 22, in various implementations the system 100 may provide control of a seed delivery motor 62 via a control module 50 if the vision sensor 30 and subsequent processing sees a seed tumbling or bouncing. If the seed 20 is recognized as tumbling in the seed furrow 2 and the system 100 may be equipped with a powered seed delivery tube 14, such that the exit speed can be adjusted to minimize seed tumble, as would be understood.

In various implementations, the vision sensor 30 is a RGB camera capable of take photos and/or video, optionally at high speed. Additional sensors 40 can be deployed alongside such a camera such as a stereo camera or a time-of-flight sensor. These additional sensors 40 may optionally be configured to gather depth data. In further optionally implementations, an additional sensor 40 employing other wavelengths of light (outside of the visual spectrum) may be used to record additional data.

Although the disclosure has been described with references to various embodiments, persons skilled in the art will recognized that changes may be made in form and detail without departing from the spirit and scope of this disclosure.

What is claimed is:

1. A system for monitoring a seed trench comprising a vision sensor disposed at a distal end of a seed tube.

2. The system of claim 1, further comprising:
(a) a video processor in communication with the vision sensor; and
(b) a display in communication with the video processor,
wherein the display is configured to display images from the vision sensor to an operator.

3. The system of claim 1, wherein the vision sensor faces a closing disk, and wherein the vision sensor is disposed at or below ground level during planting operations.

4. The system of claim 2, wherein the system is configured to detect one or more of collapsed trench sidewalls, seed placement, crop residue within the trench, clods within the trench, a collapsed trench, “W” trench, trench size, seed depth, closing wheel operations, and soil moisture.

5. The system of claim 4, wherein the system is configured to detect seed bounce by comparing a seed path through images from the vision sensor to a desired seed path.

6. The system of claim 4, wherein the display is configured display notifications to an operator of detected conditions.

7. The system of claim 2, further comprising at least one control module in communication with the display and wherein the system is configured to send commands to the at least one control module to adjust one or more of seed meter ejection, in-furrow liquid treatment, supplemental row unit down force, supplemental closing wheel down force, seed firmer deployment and down force, row cleaners, and gauge wheel load.

8. The system of claim 1, further comprising a supplemental lighting source disposed near the vision sensor.

9. The system of claim 2, further comprising a storage medium in communication with the video processor and configured to store images from the vision sensor.

10. The system of claim 1, further comprising one or more additional sensors including a stereo camera and time-of-flight sensor disposed on the seed tube.

11. The system of claim 1, wherein the vision sensor is an RGB camera.

12. An agricultural monitoring and control system comprising:
(a) a vision sensor mounting at a distal end of a seed tube and configured to capture images of an open seed trench;
(b) a video processor in communication with the vision sensor;
(c) a control module in communication with the video processor;
(d) a storage medium in communication with the video processor, configured to store images from the vision sensor; and
(e) a display in communication with the vision sensor, configured to display to an operator images from the vision sensor,
wherein the system is configured to detect one or more planting condition including collapsed trench sidewalls, seed placement, crop residue within the trench, clods within the trench, a collapsed trench, “W” trench, trench size, seed depth, closing wheel operations, soil moisture, and seed bounce, and
wherein the control module is configured to send command to equipment on a row unit to correct detected planting conditions.

13. The system of claim 12, further comprising a supplemental lighting source disposed near the vision sensor.

14. The system of claim 12, further comprising displaying alerts of detected planting conditions to an operator via the display.

15. The system of claim 12, wherein planting conditions are detected via machine learning vision.

16. The system of claim 12, further comprising a GNSS unit in communication with the video processor, and wherein the system is configured to record geolocations for the images from the vision sensor.

17. The system of claim 12, wherein planting conditions are corrected by adjusting one or more of planter row cleaners, supplemental row unit down force, supplemental closing wheel down force, closing wheel configuration, deployment of seed firmers, timing of application of liquid treatment, and seed meter ejection.

18. The system of claim 12, further comprising one or more additional sensors including a stereo camera and time-of-flight sensor.

19. The system of claim 12, wherein the vision sensor is an RGB camera.

20. A planting system comprising:
(a) a camera disposed at a distal end of a seed tube at or below ground level;
(b) a supplemental light disposed on the seed tube, configured to illuminate a field-of-view of the camera;
(c) a processor in communication with the camera configured to processes images from the camera, wherein the processor is configured to conduct image analysis to detect planting conditions including one or more of collapsed trench sidewalls, seed placement, crop residue within the trench, clods within the trench, a collapsed trench, “W” trench, trench size, seed depth, closing wheel operations, soil moisture, and seed bounce;
(d) a display in communication with the camera and processor configured to display images from the camera to an operator and to display notification of detected planting conditions;
(e) a command module in communication with the processor configured to automatically adjust one or more of planter row cleaners, supplemental row unit down force, supplemental closing wheel down force, closing wheel configuration, deployment of seed firmers, timing of application of liquid treatment, and seed meter ejection in response to detected planting conditions; and
(f) a storage medium in communication with the processor configured to store images from the camera.
